(19) United States
(12) Patent Application Publication
(10) Pub. No.: US 2011/0070994 A1
(43) Pub. Date: Mar. 24, 2011

(54) Differential with Coaxial Input Axle and Output Axle Assembly for Facilitating Reverse Gear

(76) Inventor: Jih-Kuei Cho, Guanyin Township (TW)

(21) Appl. No.: 12/565,819

(22) Filed: Sep. 24, 2009

(51) Int. Cl. F16H 48/22

(52) U.S. Cl. 475/223

(57) ABSTRACT

A differential includes a coaxial input axle and output axle assembly comprising an input axle and an output axle; a first gear mounted in the assembly; a second gear mounted in the assembly and operatively connected to the output axle; a clutch mounted in the assembly between the first gear and the second gear and operatively connected to the assembly wherein a distance between the first gear and the input axle is less than that between the second gear and the input axle; a first driven shaft comprising a third gear operatively connected thereto, the third gear being meshed with the first gear; and a second driven shaft comprising a fourth gear and a fifth gear mounted on both ends thereof wherein the fourth gear is meshed with the third gear and the fifth gear is meshed with the second gear.

### BACKGROUND OF THE INVENTION

1. Field of Invention

The invention relates to differentials of motor vehicles and more particularly to a differential of a motorcycle having a coaxial input axle and output axle assembly for facilitating a reverse gear.

2. Description of Related Art

Conventionally, a differential of a motorcycle has a fixed gear ratio. This is not desirable. Moreover, it is difficult of replacing the gear of the typical differential. In addition, it has the disadvantages of being difficult of assembly and disassembly, being time consuming and labor intensive in repair, and being cost ineffective.

A conventional differential 90 of a motorcycle with variable gear ratio is shown in FIG. 6. A non-axial design is implemented by the well known differential 90. Hence, a number of limitations and drawbacks exist. For example, sprocket meshed with an input axle may interfere with an output axle. The sprocket meshed with input axle cannot be replaced with a larger sprocket. Moreover, gear ratio change is limited, input force is relatively distal from output force, and space is small. Thus, a need for improvement exists.

### SUMMARY OF THE INVENTION

It is therefore one object of the invention to provide a differential for a motor vehicle, comprising a coaxial input axle and output axle assembly comprising an input axle and an output axle spaced from the input axle; a first gear mounted on the coaxial input axle and output axle assembly; a second gear mounted on the coaxial input axle and output axle assembly and spaced from the first gear coaxially, the second gear being operatively connected to the output axle; a clutch mounted on the coaxial input axle and output axle assembly between the first gear and the second gear and operatively connected to the coaxial input axle and output axle assembly wherein a distance between the first gear and the input axle is less than that between the second gear and the input axle; a first driven shaft comprising a third gear mounted thereon for operatively connecting thereto, the third gear being meshed with the first gear; and a second driven shaft comprising a fourth gear and a fifth gear mounted on both ends thereof wherein the fourth gear is meshed with the third gear and the fifth gear is meshed with the second gear; whereby in a first mode, engaging the clutch with the second gear will transmit power from the input axle to the output axle with both the input axle and the output axle rotating in the same direction; and whereby in a second mode, engaging the clutch with the first gear will transmit power from the input axle to the output axle by engaging the first driven shaft with the second driven shaft with the input axle and the output axle rotating in an opposite direction.

In one aspect of the invention there are further provided two oil seals disposed at both ends of the coaxial input axle and output axle assembly.

In another aspect of the invention there is further provided a bearing mounted between the oil seals.

By utilizing the invention, the following advantages can be obtained. The input axle and the output axle are mounted coaxially and together are adapted to effectively carry out forward gear or reverse gear operation. The typical drawbacks including a sprocket meshed with an input axle being incapable of being replaced with a larger sprocket, gear ratio change being limited, input force being relatively distal from output force, and space being small are eliminated. Most importantly, different gear ratios can be implemented depending on load and speed requirements and a drive source is not limited to a single kind. For example, the drive source can be implemented as an internal combustion engine or an electric motor.

The above and other objects, features and advantages of the invention will become apparent from the following detailed description taken with the accompanying drawings.

### BRIEF DESCRIPTION OF THE DRAWINGS

FIG. 1 is a cross-sectional view of a differential according to the invention where forward gear operation is shown;

FIG. 2 is a side elevation of FIG. 1 with a drive source being operatively connected thereto;

FIG. 3 is a cross-sectional view of the differential according to the invention where reverse gear operation is shown;

FIG. 4 is a side elevation of FIG. 3 with the drive source being operatively connected thereto;

FIG. 5 is a perspective view of the differential according to the invention; and

FIG. 6 is a perspective view of a conventional differential of a motorcycle with variable gear ratio.

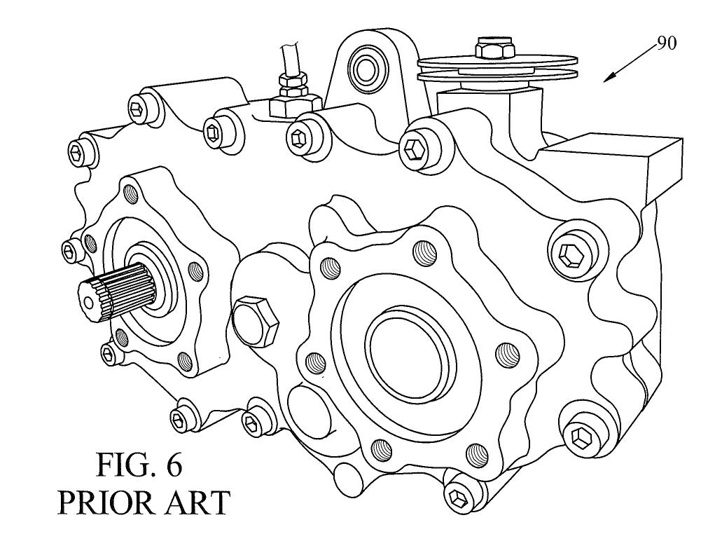

### DETAILED DESCRIPTION OF THE INVENTION

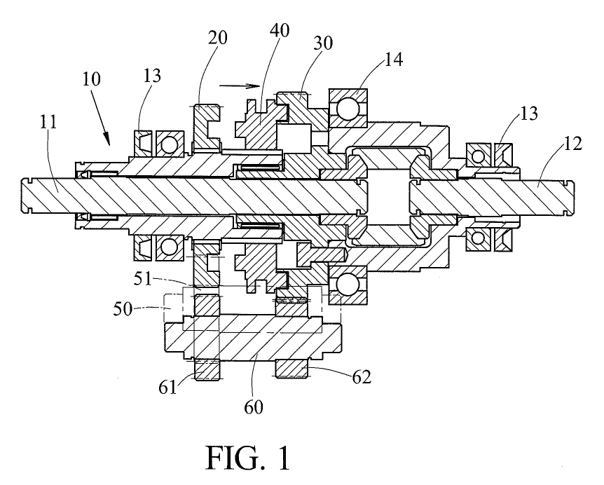

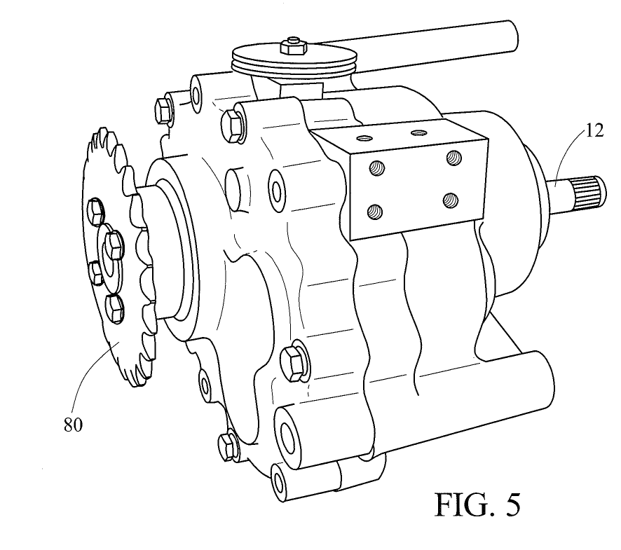

Referring to FIGS. 1 to 5, a differential in accordance with the invention is shown. The differential is mounted in a motorcycle as a preferred embodiment of the invention. The differential has a coaxial input axle and output axle assembly for facilitating reverse gear as detailed below.

The differential comprises a coaxial input axle and output axle assembly 10, a first gear 20, a second gear 30, a clutch 40, a first driven shaft 50, and a second driven shaft 60. Each of above components will now be described in detail below.

The coaxial input axle and output axle assembly 10 comprises an input axle 11 and an output axle 12. A drive source 70 has its power transmitted to a sprocket 80 via a chain (not numbered). The input axle 11 is in turn rotated by the sprocket 80. The first gear 20 on mounted in the coaxial input axle and output axle assembly 10. The second gear 30 is also mounted on the coaxial input axle and output axle assembly 10 but spaced from the first gear 20 coaxially. The second gear 30 can transmit power to the output axle 12. The clutch 40 is mounted on the coaxial input axle and output axle assembly 10 between the first gear 20 and the second gear 30. The clutch 40 is operatively connected to the coaxial input axle and output axle assembly 10. The first gear 20 is proximate to the input axle 11 while the second gear 30 is distal the input axle 11. A third gear 51 is mounted on the first driven shaft 50 so as to transmit power thereto. The third gear 51 is meshed with the first gear 20. A fourth gear 61 and a fifth gear 62 are mounted on both ends of the second driven shaft 60. The fourth gear 61 is meshed with the third gear 51. The fifth gear 62 is meshed with the second gear 30.

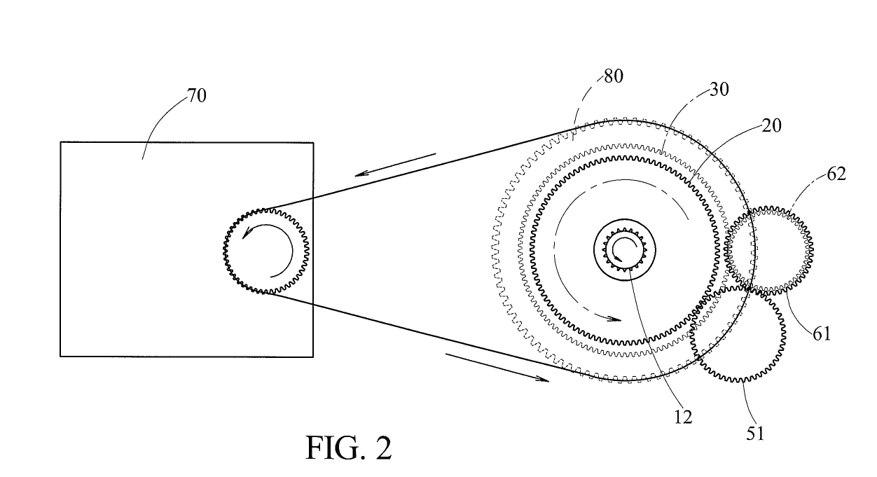

As shown in FIGS. 1 and 2, a person may manipulate a lever (not shown) to engage the clutch 40 with the second gear 30. Hence, power may be transmitted from the input axle 11 to the output axle 12 with both the input axle 11 and the output axle 12 rotating in the same direction (e.g., counterclockwise).

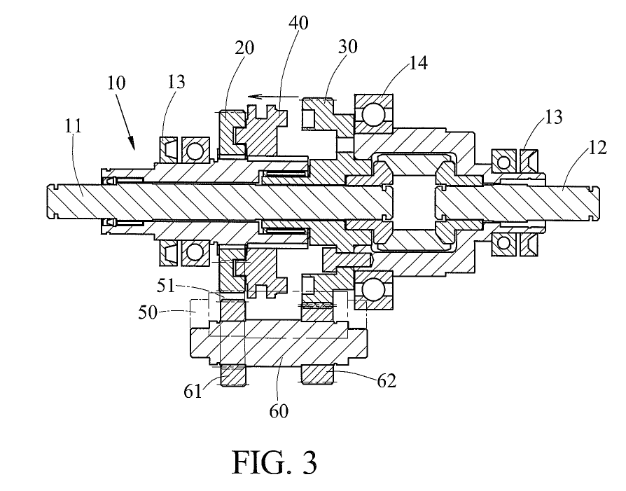

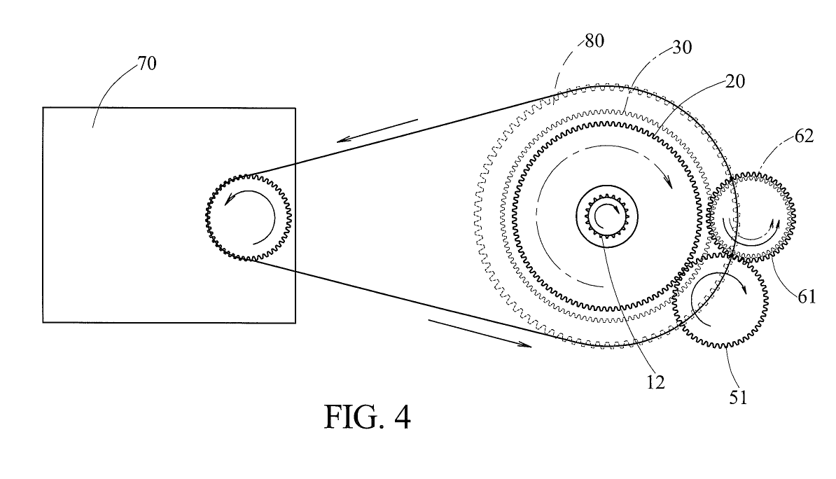

As shown in FIGS. 3 and 4, alternatively, the person may manipulate the lever to engage the clutch 40 with the first gear 20. Hence, power may be transmitted from the input axle 11 to the output axle 12 via the meshing engagement of the first driven shaft 50 and the second driven shaft 60 with the input axle 11 and the output axle 12 rotating in an opposite direction (e.g., the input axle 11 counterclockwise rotating and the output axle 12 clockwise rotating).

The drive source 70 can be implemented as an internal combustion engine or an electric motor. Hence, its applications are not limited.

The coaxial input axle and output axle assembly 10 further comprises two oil seals 13 at both ends thereof. That is, the oil seals 13 are mounted at the input axle 11 and the output axle 12 respectively.

The coaxial input axle and output axle assembly 10 further comprises a bearing 14 mounted between the other oil seal 13 on the output axle 12 and the second gear 30.

The invention has the following advantages. The input axle 11 and the output axle 12 are mounted coaxially and together are adapted to effectively carry out forward gear or reverse gear operation. Hence, the well known drawbacks including the sprocket meshed with input axle being incapable of being replaced with a larger sprocket, gear ratio change being limited, input force being relatively distal from output force, and space being small are eliminated. Most importantly, different gear ratios can be implemented depending on load and speed requirements and the drive source 70 is not limited to a single kind. For example, the drive source 70 can be implemented as an internal combustion engine or an electric motor.

While the invention herein disclosed has been described by means of specific embodiments, numerous modifications and variations could be made thereto by those skilled in the art without departing from the scope and spirit of the invention set forth in the claims.

What is claimed is:

1. A differential for a motor vehicle, comprising:
a coaxial input axle and output axle assembly comprising an input axle and an output axle spaced from the input axle and disposed in the same line as the input axle;
a first gear mounted on the coaxial input axle and output axle assembly;
a second gear mounted on the coaxial input axle and output axle assembly and spaced from the first gear coaxially, the second gear being operatively connected to the output axle;
a clutch mounted on the coaxial input axle and output axle assembly between the first gear and the second gear and operatively connected to the coaxial input axle and output axle assembly wherein a distance between the first gear and the input axle is less than that between the second gear and the input axle;
a first driven shaft comprising a third gear mounted thereon for operatively connecting thereto, the third gear being meshed with the first gear; and
a second driven shaft comprising a fourth gear and a fifth gear mounted on both ends thereof wherein the fourth gear is meshed with the third gear and the fifth gear is meshed with the second gear;
whereby in a first mode, engaging the clutch with the second gear will transmit power from the input axle to the output axle with both the input axle and the output axle rotating in the same direction; and
whereby in a second mode, engaging the clutch with the first gear will transmit power from the input axle to the output axle by engaging the first driven shaft with the second driven shaft with the input axle and the output axle rotating in an opposite direction.

2. The differential of claim 1, further comprising two oil seals disposed at both ends of the coaxial input axle and output axle assembly.

3. The differential of claim 2, further comprising a bearing mounted between the oil seals.
